(19) United States
(12) Patent Application Publication
(10) Pub. No.: US 2026/0220802 A1
(43) Pub. Date: Jul. 30, 2026

(54) SYSTEM AND METHOD FOR CREATING DEPTH MAPS AND DETECTING MOTION, AND CORRESPONDING MOTOR VEHICLE

(71) Applicants: Robert Bosch GmbH, Stuttgart (DE); CARIAD SE, Wolfsburg (DE)

(72) Inventor: Christopher Herbon, Stuttgart (DE)

(21) Appl. No.: 19/460,768

(22) Filed: Jan. 27, 2026

(30) Foreign Application Priority Data
Jan. 28, 2025 (DE) 10 2025 102 998.9

(51) Int. Cl. G06T 7/579; G06T 7/246

(52) U.S. Cl. CPC G06T 7/579; G06T 7/248

(57) ABSTRACT

A method is for creating depth maps of a plurality of sensor images of a sensor that is moving. The method includes using the sensor to create and store the plurality of sensor images for a predetermined plurality of time points within a time interval. The sensor image is generated at each time point of the predetermined plurality of time points. The method further includes recording motion information of the sensor, and labeling at least one sensor image of the plurality of sensor images as a key image of a plurality of key images based on the motion information for a first number of time points of the predetermined plurality of time points. The method includes determining at least one first optical flow based on at least one key image of the plurality of key images and at least one sensor image of the plurality of sensor images.

This application claims priority under 35 U.S.C. § 119 to patent application no. 10 2025 102 998.9, filed on Jan. 28, 2025 in Germany, the disclosure of which is incorporated herein by reference in its entirety.

The disclosure relates to a computer-implemented method for creating depth maps. Furthermore, the disclosure relates to a computer-implemented method for motion detection. The disclosure also relates to a control unit configured to perform such a method, and to a motor vehicle comprising a sensor and such a control unit.

### BACKGROUND

It is known that in modern computer vision systems, particularly in automotive and robotic applications, there are many competing requirements with respect to motion estimation in a sensor image and with respect to a sensor motion estimation. On the one hand, minimal movement of the sensor is necessary for visual odometry. On the other hand, if the sensor does not move to the greatest extent possible, it is advantageous to estimate motion in the sensor image.

From Zhang et al., “Keyframe Detection for Appearance-Based Visual Slam,” in 2010 IEEE/RSJ International Conference on Intelligent Robots and Systems, pages 2071-2076. IEEE, 2010 and Bellavia et al, “Selective Visual Odometry for Accurate AUV Localization”, in Autonomous robots, 41:133-143, 2017, it is known that key images can be used for visual odometry. In this respect, from Dias et al., “Keyframe Selection for Visual Localization and Mapping Tasks: A Systematic Literature Review” in robotics, 12 (3): 88, 2023 a plurality of options for selecting key images are known.

### SUMMARY

In the context of the present technical teaching, a motion estimation is in particular understood to mean estimating a motion of at least one object in a sensor image. In this case, the at least one object is in particular a single object, a static world in its entirety, or a part of the static world, in particular a road.

In the context of the present technical teaching, a sensor motion estimation is understood to mean, in particular, the estimation of a motion by a sensor generating the sensor images.

In the context of the present technical teaching, the optical flow is in particular understood to mean pixel-by-pixel movement in a sensor image.

The computer-implemented method having the features described herein has the advantage that an optical flow and a key depth map are determined simultaneously and in real time. Furthermore, at any time, the optical flow and key depth map may be determined. Advantageously, the combination of key images and sensor images, particularly not labeled as key images, makes determining the optical flow and key depth maps more robust and accurate. Additionally, due to the combination of key images and sensor images, particularly not labeled as key images, determination of the optical flow and key depth maps may be performed even if the sensor is not moving. Advantageously, by considering the detected motion information when labeling the key images, it is ensured that the key images are not too similar and that, at high sensor speeds of movement, the optical flow is reliably and accurately determined. According to the disclosure, a plurality of sensor images is created and stored by means of a sensor for a predetermined plurality of time points within a time interval. At each time point, a sensor image is generated. Furthermore, motion information of the sensor is recorded. The associated sensor images are labeled as key images at least as a function of the detected motion information for a first number of the plurality of time points. At least a first optical flow is determined, at least as a function of at least one key image and at least one sensor image, which is in particular not labeled as a key image. Additionally, a key depth map is determined at least as a function of the at least one first optical flow. In particular, as a function of the detected motion information, a subset of the plurality of sensor images is labeled as key images. In one embodiment, the motion information is a predetermined sensor motion length. A sensor image is always labeled as a key image if the sensor has traveled at least the predetermined sensor movement length from the time of the last key image. Thus, the first number of the plurality of time points is selected such that the sensor has traveled at least the predetermined sensor motion length in the time between two consecutive time points of the first number. In particular, a travel distance of at least 1 cm up to a maximum of 300 cm, preferably 15 cm, preferably 25 cm, preferably 50 cm, preferably 100 cm, is selected as the predetermined sensor motion length. Advantageously, this ensures that the time intervals between two key images change as a function of a sensor motion speed, in particular, the time interval is reduced when increasing the sensor motion speed. In an alternative configuration, the sensor motion speed is used as the motion information. A sensor image is always labeled as a key image if at least one travel distance based on the sensor motion speed has been traveled from the time of the last key image. Preferably, at each time point of the first number of time points, the sensor image is labeled as a key image and the first optical flow is determined, so that the first number of optical flows are also determined. Furthermore, at each time point of the first number of time points, a key depth map is additionally determined such that the first number of key depth maps is also determined. Preferably, in addition to at least one time point, particularly at each time point from the second time point, of the first number of time points, a sensor motion estimate is determined between the current key image and the chronologically previous key image. Advantageously, the sensor motion estimate is also determined simultaneously with the optical flow and in real time. In particular, the method may be performed with mono sensors.

Particularly preferably, it is contemplated that, for a predetermined second number of the plurality of time points, the associated sensor images are labeled as fixed images. In addition, at least a second optical flow is determined at least as a function of two chronologically sequential fixed images. In particular, a second optical flow is determined at each time point of the second number of time points, particularly from the second time point of the second number of time points. A fixed depth map is determined at least as a function of the at least one second optical flow. Furthermore, a depth map fusion is performed at least as a function of the key depth map and the fixed depth map, thereby obtaining a fusion depth map. Advantageously, the depth values stored in the key depth map are improved by the depth map fusion with the fixed depth map. Furthermore, advantageously at least two optical flows are determined simultaneously, which are used to determine depth values.

According to a preferred further development of the disclosure, it is contemplated that the predetermined plurality of time points has a predetermined initial time interval with respect to each other. Furthermore, the first number of time points have a first time interval with respect to each other. The first time interval is greater than or equal to the initial time interval. Additionally, the first time interval is dependent on the recorded motion information. Advantageously, this ensures that a current sensor image is present at the time point at which a sensor image is labeled as a key image. In particular, the initial time interval is selected as the reciprocal of an imaging frequency of the sensor, wherein the imaging frequency is preferably 30 Hz.

Particularly preferably, it is contemplated that the predetermined plurality of time points has the predetermined initial time interval with respect to each other. Furthermore, the predetermined second number of time points have a second time interval with respect to each other. The initial time interval is shorter than the second time interval. Advantageously, this ensures that a current sensor image is present at the time point at which a sensor image is labeled as a fixed image. Furthermore, it is thus possible for the first time interval between the key images to be shorter or longer than the second time interval between the fixed images.

According to a preferred further development of the disclosure, it is provided that the motion information of the sensor is recorded at each time point of the plurality of time points. The first time interval is determined based on the recorded motion information at each time point of the plurality of time points. Advantageously, the labeling of the sensor images as key images is thus adaptively adjusted to a current situation in real time, in particular a current motion of the sensor.

Particularly preferably, it is contemplated that the at least one first optical flow be determined as a function of at least one sensor image and a plurality of key images. A key image of the plurality of key images and a sensor image of the at least one sensor image are each selected such that a time associated with the key image is chronologically prior to a time point associated with the sensor image. Additionally, a duration between the time point associated with the key image and the time point associated with the sensor image is greater than or equal to the first time interval. Moreover, the duration is less than two times the first time interval. Advantageously, an optimal time interval between the sensor image used and the key image used is thus realized so that the optical flow is determined robustly and accurately.

According to a preferred further development of the disclosure, it is provided that if the first time interval is the same as the initial time interval, the duration between the time point associated with the key image and the time point associated with the sensor image is the same as the first time interval. Advantageously, an optimal time interval between the sensor image used and the key image used is thus realized so that the optical flow is determined robustly and accurately.

Particularly preferably, it is provided that a motion estimate is made at least as a function of the at least one first optical flow and the at least one second optical flow. The key depth map is further determined as a function of the motion estimate. In addition, the fixed depth map is determined as a function of the motion estimate.

In the computer-implemented method according to the disclosure with the features described herein, a key depth map and/or a fusion depth map is determined by means of a computer-implemented method according to the disclosure. Furthermore, motion in at least one sensor image of the plurality of sensor images is detected at least as a function of the key depth map and/or the fusion depth map. In connection with the motion detection method, the advantages particularly arise that have already been explained in connection with the computer-implemented method for creating depth maps. Advantageously, the method is thus usable in all computer vision systems.

The control unit according to the disclosure with the features described herein is specially configured to perform the computer-implemented method for the creation of depth maps according to the disclosure when used as intended. Alternatively or additionally, the control unit according to the disclosure with the features described herein is specially configured to perform the computer-implemented method for motion detection according to the disclosure when used as intended. In connection with the control unit, the advantages particularly arise that have already been explained in connection with the computer-implemented method for creating depth maps and for motion detection.

The motor vehicle according to the disclosure with the features described herein comprises a sensor and the control unit according to the disclosure. In connection with the motor vehicle, the advantages particularly arise that have already been explained in connection with the computer-implemented method for creating depth maps and for motion detection and for the control unit.

### BRIEF DESCRIPTION OF THE DRAWINGS

Further advantages and preferred features and combinations of features result in particular from the previous descriptions and from the claims. The disclosure will be explained in more detail below with reference to the drawings. Shown are:

FIG. 1 a schematic representation of an exemplary embodiment of a motor vehicle,

FIG. 2 flow chart of an exemplary embodiment of a computer-implemented method,

FIG. 3A a first time sequence of a plurality of sensor images and labeling of key images and fixed images,

FIG. 3B a second time sequence of a plurality of sensor images and labeling of key images and fixed images, and

FIG. 3C a third time sequence of a plurality of sensor images and labeling of key images and fixed images.

### DETAILED DESCRIPTION

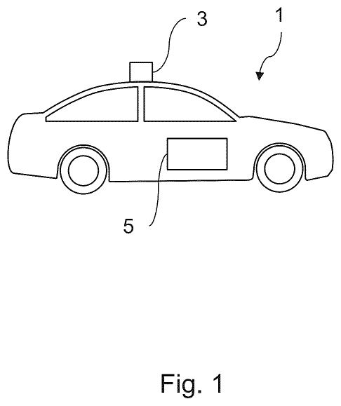

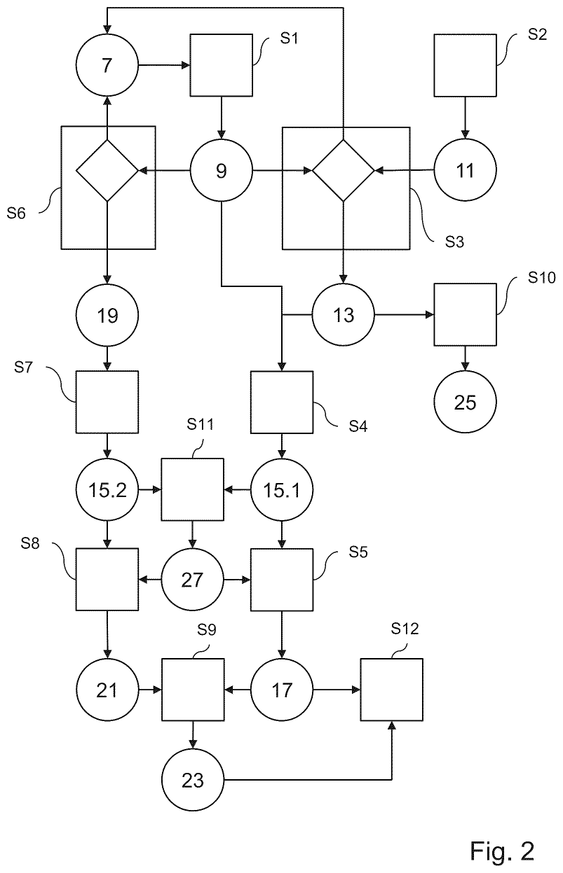

FIG. 1 shows a schematic diagram of an exemplary embodiment of a motor vehicle 1 with a sensor 3 and a control unit 5. In particular, the sensor 3 is a mono sensor. Control unit 5 is operatively connected to the sensor 3 in a manner not explicitly shown and configured to control it. Furthermore, control unit 5 is specially configured to perform, when used as intended, a method for creating depth maps and a method for movement detection. A preferred embodiment of the method is explained in more detail in FIG. 2.

FIG. 2 shows a flow chart of an exemplary embodiment of a computer-implemented method for creating depth maps.

Like and identical elements are provided with the same reference numerals in all figures, so that reference is made to the foregoing description in this respect.

In a step S1, a plurality of sensor images 9 is created and stored by means of the sensor 3 for a predetermined plurality of time points 7 within a time interval. At each time point (7), a sensor image (9) is generated. In particular, the predetermined plurality of time points 7 have a predetermined initial time interval with respect to each other, preferably wherein the initial time interval is selected as the reciprocal of an imaging frequency of the sensor 3. Preferably, the imaging frequency is 30 Hz, and thus the initial time interval is about 33 ms.

In a step S2, motion information 11 of the sensor 3 is recorded. In particular, the motion information 11 of the sensor 3 is recorded at each time point 7 of the plurality of time points 7.

In a step S3, the associated sensor images 9 are labeled as key images 13 at least as a function of the recorded motion information 11 for a first number of the plurality of time points 7. In particular, as a function of the recorded motion information 11, a subset of the plurality of sensor images 9 is labeled as key images 13. In particular, the first number of time points have a first time interval with respect to each other, preferably wherein the first time interval is determined at each time point 7 of the plurality of time points 7 based on the recorded motion information 11. The first time interval is preferably greater than or equal to the initial time interval. Particularly preferably, a predetermined sensor motion length, in particular a distance of at least 1 cm to a maximum of 300 cm, is used as the motion information 11. Particularly preferably, at each time point 7 of the plurality of time points 7, it is checked whether the predetermined sensor motion length has been traveled since the last time a sensor image 9 was labeled as a key image 13. If yes, the sensor image 7 associated with the current time point 7 will be labeled as the key image 13. If no, the next time point 7 is awaited.

In a step S4, at least a first optical flow 15.1 is determined at least as a function of at least one key image 13, preferably a plurality of key images 13, and at least one sensor image 9, which is in particular not labeled as a key image 13. Preferably, at each time point 7 of the first number of time points 7, the first optical flow 15.1 is determined so as to also determine the first number of optical flows 15.1. In particular, a key image 13 of the plurality of key images 13 and a sensor image 9 of the at least one sensor image 9 are each selected such that a time 7 associated with the key image 13 is chronologically prior to a time point 7 associated with the sensor image 9. Preferably, a duration between the time point 7 associated with the key image 13 and the time 7 associated with the sensor image 9 is greater than or equal to the first time interval and the duration is less than twice the first time interval. Moreover, if the first time interval is the same as the initial time interval, preferably the duration between the time point 7 associated with the key image 13 and the time point 7 associated with the sensor image 9 is the same as the first time interval.

In a step S5, a key depth map 17 is determined at least as a function of the at least one first optical flow 15.1. Preferably, at each time point 7 of the first number of time points 7, a key depth map 17 is determined so that the first number of key depth maps 17 is also determined. Preferably, the key depth map 17 is additionally determined as a function of a motion estimate 27.

In an optional step S6, the associated sensor images 9 are labeled as fixed images 19 for a predetermined second number of the plurality of time points 7. In particular, the predetermined second number of time points 7 have a second time interval with respect to each other, wherein the initial time interval is less than the second time interval. Particularly preferably, at each time point 7 of the plurality of time points 7, it is checked whether the second time interval has passed since the last time a sensor image 9 was labeled as a fixed image 19. If yes, the sensor image 7 associated with the current time point 7 is labeled as a fixed image 19. If no, the next time point 7 is awaited.

In a further optional step S7, at least a second optical flow 15.2 is determined at least as a function of two chronologically sequential fixed images 19. In particular, a second optical flow 15.2 is determined at each time point 7 of the second number of time points 7, particularly from the second time point 7 of the second number of time points 7.

In a further optional step S8, a fixed depth map 21 is determined at least as a function of the at least one second optical flow 15.2. Preferably, the fixed depth map 21 is additionally determined as a function of the motion estimate 27.

In a further optional step S9, a depth map fusion is performed at least as a function of the key depth map 15.1 and the fixed depth map 15.2, thereby obtaining a fusion depth map 23.

In a further optional step S10, in addition to at least one time point 7, particularly at each time point 7 from the second time point 7, of the first number of time points 7, a sensor motion estimate 25 is determined between the current key image 13 and the chronologically previous key image 13.

In a further optional step S11, a motion estimate 27 is made at least as a function of the at least one first optical flow 15.1 and the at least one second optical flow 15.2.

In a further optional step S12, motion in at least one sensor image 9 of the plurality of sensor images 9 is detected at least as a function of the key depth map 17 and/or the fusion depth map 23.

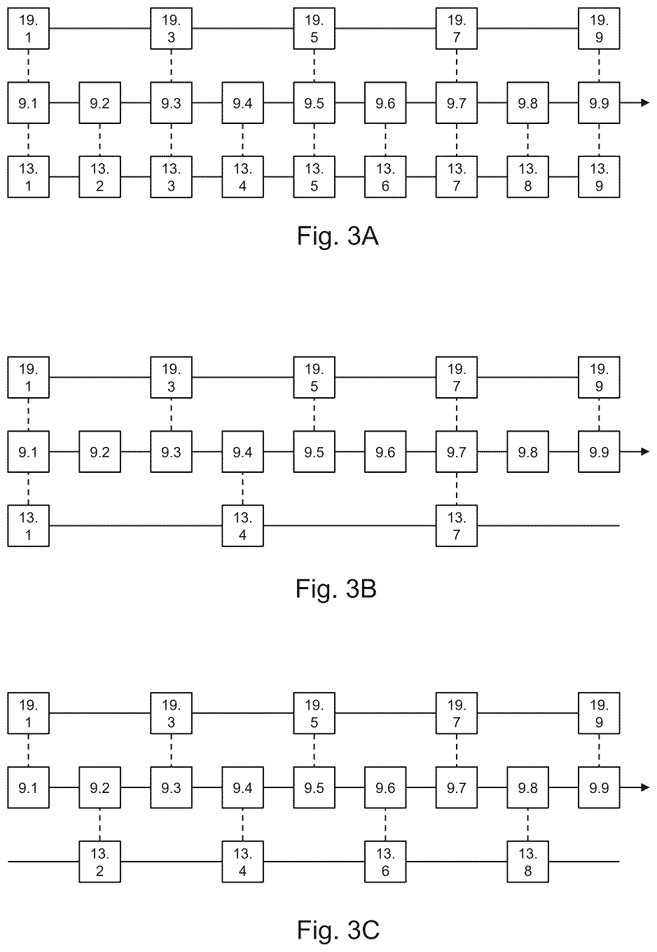

FIGS. 3A, 3B, and 3C show three time sequences of a plurality of sensor images 9 and labeling of key images 13 and fixed images 19.

Each image, sensor image 9, key image 13 and fixed image 19, is provided with the respective reference numeral and a label of the associated time point. The reference numeral and time point label are separated by a dot. Furthermore, the sensor motion speed is constant in all examples.

In all three examples, at nine chronologically sequential time points 7, each having the initial time interval, in particular a unit of time, preferably the reciprocal value of the imaging frequency of 30 Hz, the sensor images 9 are taken. These are then provided with reference numerals 9.1, 9.2, 9.3, 9.4, 9.5, 9.6, 9.7, 9.8 and 9.9.

In all three examples, the associated sensor images 9 are also labeled as fixed images 19 at five successive time points 7, each having the second time interval with respect to each other, in particular two units of time. These are then provided with reference numerals 19.1, 19.3, 19.5, 19.7 and 19.9. The second optical flow 15.2 is then determined at least as a function of two chronologically sequential fixed images 19. A second optical flow 15.2 is determined at least as a function of the fixed images 19.1 and 19.3. Alternatively or additionally, a further second optical flow 15.2 is determined at least as a function of the fixed images 19.3 and 19.5. Alternatively or additionally, a further second optical flow 15.2 is determined at least as a function of the fixed images 19.5 and 19.7. Alternatively or additionally, a further second optical flow 15.2 is determined at least as a function of the fixed images 19.7 and 19.9.

FIG. 3A shows the labeling of the key images 13 with a high sensor motion speed. The predetermined sensor motion length is traveled within a short time, so that many sensor images 9 are labeled as key images 13 and the first time interval is small. In particular, the first time interval is the same as the initial time interval and thus smaller than the second time interval. Each sensor image 9 is labeled as a key image 13. These are then provided with reference numerals 13.1, 13.2, 13.3, 13.4, 13.5, 13.6, 13.7, 13.8 and 13.9. The first optical flux 15.1 is then determined at least as a function of a sensor image 9 and the chronologically previous key image 13. A first optical flow 15.1 is determined at least as a function of the sensor image 9.2 and the key image 13.1. Alternatively or additionally, a further first optical flow 15.1 is determined at least as a function of the sensor image 9.2 and the key image 13.1. Alternatively or additionally, a further first optical flow 15.1 is determined at least as a function of the sensor image 9.3 and the key image 13.2. Alternatively or additionally, a further first optical flow 15.1 is determined at least as a function of the sensor image 9.4 and the key image 13.3. Alternatively or additionally, a further first optical flow 15.1 is determined at least as a function of the sensor image 9.5 and the key image 13.4. Alternatively or additionally, a further first optical flow 15.1 is determined at least as a function of the sensor image 9.6 and the key image 13.5. Alternatively or additionally, a further first optical flow 15.1 is determined at least as a function of the sensor image 9.7 and the key image 13.6. Alternatively or additionally, a further first optical flow 15.1 is determined at least as a function of the sensor image 9.8 and the key image 13.7. Alternatively or additionally, a further first optical flow 15.1 is determined at least as a function of the sensor image 9.9 and the key image 13.8.

FIG. 3B shows the labeling of the key images 13 with a low sensor motion speed. The predetermined sensor motion length is traveled over a long time, so that few sensor images 9 are labeled as key images 13 and the first time interval is large. In particular, the first time interval is longer than the second time interval. The associated sensor images 9 are also labeled as key images 13 at three successive time points 7, each having the first time interval, in particular three units of time. These are then provided with reference numerals 13.1, 13.4 and 13.7. The first optical flux 15.1 is then determined at least as a function of a sensor image 9 and a chronologically previous key image 13, wherein a duration between the time point 7 associated with the key image 13 and the time point 7 associated with the sensor image 9 is greater than or equal to the first time interval, and wherein the duration is less than two times the first time interval. A first optical flow 15.1 is determined at least as a function of the sensor image 9.4 and the key image 13.1. Alternatively or additionally, a further first optical flow 15.1 is determined at least as a function of the sensor image 9.5 and the key image 13.1. Alternatively or additionally, a further first optical flow 15.1 is determined at least as a function of the sensor image 9.6 and the key image 13.1. Alternatively or additionally, a further first optical flow 15.1 is determined at least as a function of the sensor image 9.7 and the key image 13.4. Alternatively or additionally, a further first optical flow 15.1 is determined at least as a function of the sensor image 9.8 and the key image 13.4. Alternatively or additionally, a further first optical flow 15.1 is determined at least as a function of the sensor image 9.9 and the key image 13.4.

FIG. 3C shows the labeling of the key images 13 with a middle sensor motion speed. The predetermined sensor motion length is traveled such that the first time interval and the second time interval are the same. In this case, the same sensor images 7 are not then labeled as both a key image 13 and a fixed image 19, but rather the time points of labeling are offset from each other. The associated sensor images 9 are labeled as key images 13 at four successive time points 7, each having the first time interval, in particular two units of time. These are then provided with reference numerals 13.2, 13.4, 13.6 and 13.8. The first optical flux 15.1 is then determined at least as a function of a sensor image 9 and a chronologically previous key image 13, wherein a duration between the time point 7 associated with the key image 13 and the time point 7 associated with the sensor image 9 is greater than or equal to the first time interval, and wherein the duration is less than two times the first time interval. A first optical flow 15.1 is thus determined at least as a function of the sensor image 9.4 and the key image 13.2. Alternatively or additionally, a further first optical flow 15.1 is determined at least as a function of the sensor image 9.5 and the key image 13.2. Alternatively or additionally, a further first optical flow 15.1 is determined at least as a function of the sensor image 9.6 and the key image 13.4. Alternatively or additionally, a further first optical flow 15.1 is determined at least as a function of the sensor image 9.7 and the key image 13.4. Alternatively or additionally, a further first optical flow 15.1 is determined as a function of the sensor image 9.8 and the key image 13.6. Alternatively or additionally, a further first optical flow 15.1 is determined at least as a function of the sensor image 9.9 and the key image 13.6.

What is claimed is

1. A computer-implemented method for creating depth maps of a plurality of sensor images of a sensor that is moving, the computer-implemented method comprising:
creating and storing the plurality of sensor images, using the sensor, for a predetermined plurality of time points within a time interval, wherein a sensor image is generated at each time point of the predetermined plurality of time points;
recording motion information of the sensor;
labeling at least one sensor image of the plurality of sensor images as a key image of a plurality of key images based on the motion information for a first number of time points of the predetermined plurality of time points;
determining at least one first optical flow based on at least one key image of the plurality of key images and at least one sensor image of the plurality of sensor images; and
determining a key depth map at least as a function of the at least one first optical flow.

2. The computer-implemented method according to claim 1, further comprising:
labeling at least one sensor image of the plurality of sensor images as a fixed image of a plurality of fixed images for a predetermined second number of time points of the predetermined plurality of time points;
determining at least one second optical flow based on two chronologically sequential fixed images of the plurality of fixed images;
determining a fixed depth map based on the at least one second optical flow; and
obtaining a fusion depth map by performing a depth map fusion based on the key depth map and the fixed depth map.

3. The computer-implemented method according to claim 2, wherein:
the time points of the predetermined plurality of time points have a predetermined initial time interval with respect to each other,
the first number of time points have a first time interval with respect to each other,
the first time interval is greater than or equal to the predetermined initial time interval, and the first time interval is dependent on the motion information.

4. The computer-implemented method according to claim 3, wherein:
the time points of the predetermined second number of time points have a second time interval with respect to each other, and
the predetermined initial time interval is shorter than the second time interval.

5. The computer-implemented method according to claim 3, further comprising:
recording the motion information of the sensor at each time point of the predetermined plurality of time points; and
determining the first time interval based on the motion information at each time point of the predetermined plurality of time points.

6. The computer-implemented method according to claim 3, further comprising:
determining the at least one first optical flow based on the at least one sensor image and at least two key images of the plurality of key images;
a selected key image of the plurality of key images and a selected sensor image of the at least one sensor image are each selected such that a first time point of the predetermined plurality of time points associated with the selected key image is chronologically prior to a second time point of the predetermined plurality of time points associated with the selected sensor image,
a duration between the first time point and the second time point is greater than or equal to the first time interval, and
the duration is less than two times the first time interval.

7. The computer-implemented method according to claim 6, wherein, when the first time interval is equal to the predetermined initial time interval, the duration between the first time point and the second time point is equal to the first time interval.

8. The computer-implemented method according to claim 7, further comprising:
making a motion estimate based on the at least one first optical flow and the at least one second optical flow;
determining the key depth map based on the motion estimate; and
determining the fixed depth map based on the motion estimate.

9. A computer-implemented method for motion detection, comprising:
using the computer-implemented method according to claim 2 to determine the key depth map and/or the fusion depth map; and
detecting movement in at least one sensor image of the plurality of sensor images based on the key depth map and/or the fusion depth map.

10. A control unit configured to perform the computer-implemented method of claim 1.

11. A motor vehicle comprising:
the sensor; and
the control unit according to claim 10.
